(19) United States
(12) Patent Application Publication
(10) Pub. No.: US 2024/0126969 A1
(43) Pub. Date: Apr. 18, 2024

(54) Techniques For Configuring Computing Nodes In A Computing System

(71) Applicant: Altera Corporation, San Jose, CA (US)

(72) Inventor: Steven Jahnke, Dallas, TX (US)

(73) Assignee: Altera Corporation, San Jose, CA (US)

(21) Appl. No.: 18/390,609

(22) Filed: Dec. 20, 2023

(51) Int. Cl. G06F 30/34

(52) U.S. Cl. CPC G06F 30/34

(57) ABSTRACT

An integrated circuit includes logic circuits that are configurable by a bitstream of configuration data to perform a computing service requested in a computing system. The integrated circuit communicates with a central processing unit in the computing system according to interface features indicated by meta-data provided to the central processing unit to perform the computing service.

### TECHNICAL FIELD

The present disclosure relates to electronic computing systems, and more particularly to circuits, systems, and methods for configuring computing nodes in a computing system to perform computing services.

### BACKGROUND

Configurable integrated circuits (ICs) can be configured by users to implement desired custom logic functions. In a typical scenario, a logic designer uses computer-aided design (CAD) tools to design a custom circuit design. When the design process is complete, the computer-aided design tools generate an image containing configuration data. The configuration data is then loaded into configuration memory elements that configure configurable logic circuits in the integrated circuit to perform the functions of the custom circuit design.

### BRIEF DESCRIPTION OF DRAWINGS

FIG. 1 is a diagram of an orchestration and provisioning computing system that includes a primary computing node that controls secondary computing nodes.

FIG. 2 is a diagram that illustrates an example of a configurable logic integrated circuit that can implement techniques disclosed herein.

FIG. 3 is a block diagram of a system that can be used to implement a circuit design to be programmed onto a programmable logic device using design software.

FIG. 4 is a diagram that depicts an example of a programmable logic device that includes a fabric die and a base die that are connected to one another via microbumps.

FIG. 5 is a block diagram illustrating a computing system configured to implement one or more aspects of the embodiments disclosed herein.

### DETAILED DESCRIPTION

A field programmable gate array (FGPA) is a type of configurable integrated circuit. In a traditional FPGA deployment (e.g., in a cloud computing environment), an FPGA is used both as an accelerator with a host and to provide dynamic or custom interface capability via networking or host interface standards. Traditionally, the accelerator features are exposed and integrated into an orchestration and provisioning solution as a software-definable element.

FPGAs have been used as accelerators as part of a node in a computing system. The accelerator functions are orchestrated as any other compute solution. The interface characteristics are not presented to the provisioning elements, because in most implementations, the interface characteristics are immutable. However, with an FPGA, not only does the accelerator functionality dynamically change, the interface (i.e., host, network, memory) characteristics, such as throughput, latency, power consumption, and security, may also change.

Previously known heterogenous cloud orchestration systems provide a logical functional abstraction definition that is understood by the orchestration software. For example, a function and the nodes that can perform the function are presented to the orchestration software. The orchestration software is only aware that a node has the capability to perform the function but not how the function is performed. The provisioning and execution of the function are invoked via industry-standard middleware frameworks that have an abstract function and that translate the function to the underlying hardware for execution. A node, when inserted into the network, is usually defined at this level of functionality and exposed, and fixed, to the orchestration software.

Previously known orchestration and provisioning techniques do not allow for the dynamic configurations of the interface characteristics directly, which limits significantly key advantages of an FPGA (i.e., flexible interface and compute features). To maximize full FPGA potential in a heterogenous computing system, it would be desirable to provide the ability to seamlessly integrate the interface characteristics along with a compute acceleration service. It would be desirable to be able to teach the orchestration and provisioning software the functions of available FPGA images, so that the appropriate workloads and interface specifications can be directly loaded onto the FPGA. It would also be desirable to have the provisioning software request certain interface characteristics so that an image can be built with those interface characteristics if the image does not already exist in a library.

Field programmable gate arrays (FPGAs) are unique as hardware compute or acceleration platforms in that FPGAs can provide many different acceleration or interface operations. In addition, the functionality performed by an FPGA can change during runtime by loading a new bitstream image into the FPGA. According to some examples disclosed herein, the functionality of a configurable IC, such as FPGA, can be managed dynamically as part of a cloud or enterprise orchestration and provisioning computing system.

According to some examples, a containerized application building framework (e.g., Kubernetes, docker-compose, etc.) is extended to include interface features as new configuration parameters that include fields such as throughput, latency, power, and security for each common input/output (I/O) (e.g., network, host interface, memory interface). Provisioning requests to configurable ICs include these configuration parameters as part of meta-data sent to services. The services are, as examples, contained either in a library of pre-built images, or fed into a synthesis tool to build the appropriate image for an accelerator and an interface. The image is used to configure one or more configurable ICs. Decisions on how to balance the accelerator and interface circuitry can be fixed or dynamic based on weighted characteristics of various computing needs and FPGA resources available.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the term “connected” means a direct electrical connection between the circuits that are connected, without any intermediary devices. The term “coupled” means either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) logic integrated circuits, such as field programmable gate arrays (FPGAs). As discussed herein, an integrated circuit (IC) can include hard logic and/or soft logic. The circuits in an integrated circuit device (e.g., in a configurable logic IC) that are configurable by an end user are referred to as “soft logic.” “Hard logic” generally refers to circuits in an integrated circuit device that have substantially less configurable features than soft logic or no configurable features.

An infrastructure processing unit (IPU) is a system-on-chip (SoC) having hardware accelerators that perform any infrastructure operation. An IPU can include a programmable networking device that manages system-level infrastructure resources by securely accelerating functions in a data center. An artificial intelligence (AI) engine is an SoC, graphics processing unit (GPU), application specific integrated circuit (ASIC), or configurable IC that has hardware to accelerate AI algorithms. When presented to orchestration software in a heterogenous computing system, a node can be provisioned to perform a target function. For example, a node provisioned as an IPU node is able to offload IPU-focused functions (e.g., firewall or TLS encryption or remote storage). An AI node performs AI operations for an AI-oriented service or workload. Previously known nodes are fixed in terms of functionality to the orchestration software and do not have to be dynamically provisioned.

FPGAs have increased functionality compared to targeted application specific integrated circuits (ASICs) for functional abstraction. An FPGA can take on the characteristics of either (or all) of an IPU node, AI node, or another type of node at any given time. The performance of these nodes are heavily dependent upon the I/O, and as such, may also need to be modified in order to achieve optimal application behavior. As a result, the FPGA node in a heterogenous computing system is typically not tagged as an IPU or AI node, for example, but may take on the characteristics of both types of nodes, depending on what image the FPGA is loaded with. In order to properly orchestrate such an offering, a new classification is used in the orchestration software that includes the I/O characteristics that are tied to a list of capabilities that can be loaded on the target node. The list can come from an FPGA image library, which has both the images needed to load on the FPGA as well as a manifest of all the available images and how the images map to the functional orchestration. The list can also include a set of configuration parameters to an FPGA synthesis tool to dynamically generate an image to load on the FPGA.

After a target image is selected or generated by the orchestration software, the underlying provisioning functionality is initiated. This provisioning functionality loads the FPGA with the selected or generated image, loads the appropriate middleware software onto the node to integrate the capability of the node into the greater execution environment, and notifies the orchestration software of the loaded functionality onto the FPGA node. The node then takes the form of a functional node (e.g., an IPU or AI node) and is presented to the rest of the computing environment as the functional node, including any interface configurations needed to perform the function at optimal behavior.

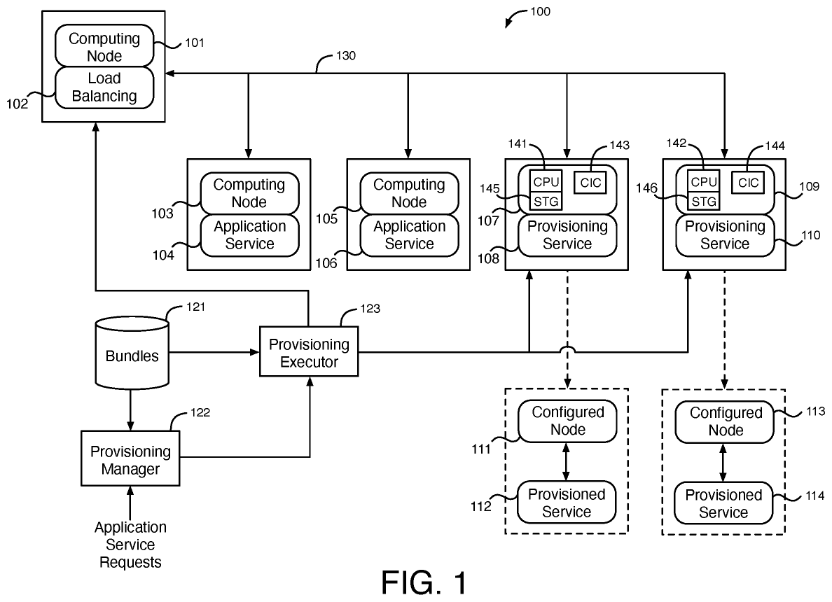

FIG. 1 is a diagram of an orchestration and provisioning computing system 100 that includes a primary computing node 101 that controls secondary computing nodes 103, 105, 107, and 109. The primary computing node 101 can, for example, be deployed in a cloud computing environment. Each of the computing nodes 101, 103, and 105 includes a computer or computing system that has memory, a central processing unit (CPU), and other computing resources. The CPU in each of the computing nodes 101, 103, and 105 can be, as examples, one or more microprocessor integrated circuits (ICs), system-on-chips (SoCs), graphics processing units (GPUs), or application specific integrated circuits (ASICs).

The primary computing node 101 runs a load balancing service 102 that can be implemented, for example, by software running on the CPU in node 101. The load balancing service 102 load balances application service requests for the primary computing node 101 between the secondary computing nodes 103, 105, 107, and 109 through a bus 130. Thus, the load balancing service 102 provides application service requests to perform various computing services to the secondary computing nodes 103, 105, 107, and 109. The secondary computing nodes 103, 105, 107, and 109 then perform the computing services associated with the application service requests and provide results of these computing services back to the primary computing node 101 through bus 130.

The secondary computing nodes 103 and 105 have fixed functionality performed by application services 104 and 106, respectively, that cannot be dynamically provisioned. As an example, if one of the secondary computing nodes 103 and 105 is provisioned as an artificial intelligence (AI) node, then that secondary computing node can only perform AI operations for an AI-oriented service or workload. As another example, if one of the secondary computing nodes 103 and 105 is provisioned as an infrastructure processing unit (IPU) node, then that secondary computing node can only perform functions associated with computing infrastructure operations. Therefore, the load balancing service 102 provides application service requests to secondary computing nodes 103 and 105 for performing computing services that can be performed by the fixed functionality of the nodes 103 and 105.

The secondary computing nodes 107 and 109 are also referred to herein as computing flex nodes. The computing flex nodes 107 and 109 have dynamic functionality that can be dynamically provisioned and performed by provisioning services 108 and 110, respectively. Each of the computing flex nodes 107 and 109 has a computer or computing system that includes a central processing unit (CPU), CPU storage, a configurable integrated circuit (CIC), and other computing resources. Computing flex node 107 includes CPU 141, CIC 143, and CPU storage (STG) 145. Computing flex node 109 includes CPU 142, CIC 144, and CPU storage (STG) 146. The configurable IC in each of the computing flex nodes 107 and 109 can include, for example, one or more configurable logic devices, such as a field programmable gate array (FPGA). The CPU in each of the computing flex nodes 107 and 109 can be, as examples, one or more microprocessor integrated circuits (ICs), system-on-chips (SoCs), graphics processing units (GPUs), or application specific integrated circuits (ASICs).

Each of the computing flex nodes 107 and 109 can be configured to perform the functions of any type of computing node in computing system 100, such as an IPU node or an AI node, by configuring the configurable IC 143 or 144 in the respective computing flex node 107 or 109 with an image containing a bitstream of configuration data. As an example, configurable IC 143 in the computing flex node 107 can be configured by an image containing a bitstream to function as a configured computing node 111 performing a provisioned service 112 requested by the load balancing service 102. As another example, configurable IC 144 in the computing flex node 109 can be configured by an image containing a bitstream to function as a configured computing node 113 performing a provisioned service 114 requested by the load balancing service 102. Each of the configured computing nodes 111 and 113 can be configured to perform the functions of any type of computing node in computing system 100, such as an IPU node or an AI node.

The computing system 100 includes a provisioning manager 122 and a provisioning executor 123 that provision the provisioning services 108 and 110 to generate the provisioned services 112 and 114 by configuring the configurable ICs 143 and 144 in the computing flex nodes 107 and 109 to generate the configured computing nodes 111 and 113, respectively. The provisioning manager 122 includes software (e.g., running on a processor circuit) that receives one or more application service requests (e.g., from load balancing service 102) to provision one or more of the secondary computing nodes in computing system 100 to perform one or more requested application services, such as a firewall service, an image recognition AI service, a user management service, a web server service, or an application accelerator.

The provisioning manager 122 receives one or more bundles 121 for the one or more applications service requests. The bundles 121 include images containing bitstreams for configuring one or more configurable ICs to perform the application services. The images containing the bitstreams for configuring the configurable ICs to perform the application services can, as examples, be accessed from a library of pre-built images or from a synthesis tool that generates appropriate images for implementing one or more of the application services.

The bundles 121 can also include meta-data for the application services. The meta-data for the bundle for an application service can include configuration parameters describing interface features that define how the host CPUs 141-142 communicate with the CICs 143-144, respectively. The meta-data provided to computing flex node 107 is used as an input to orchestration decision logic in CPU 141 to select the interface features for defining how host CPU 141 communicates with CIC 143. The meta-data provided to computing flex node 109 is used as an input to orchestration decision logic in CPU 142 to select the interface features for defining how host CPU 142 communicates with CIC 144. Alternatively, the orchestration decision logic in the CPUs 141-142 can select images containing bitstreams to load into the CICs 143-144 that are accessed from host CPU storage 145-146, respectively, based on the configuration parameters indicated by the meta-data. The meta-data indicates to the orchestration decision logic in the CPUs 141-142 what the capabilities of the CICs 143-144 are based on a library of pre-built configuration images, or as part of features that can be synthesized in a real-time synthesis of the CICs 143-144.

The host CPUs 141-142 can use the meta-data to configure or reconfigure the CPUs 141 and 142 with interface features, such as data throughput, latency, power consumption, or security features for each common input/output (I/O) (e.g., network, host interface, or memory interface). The performance of the computing flex nodes 107 and 109 may be dependent on these interface features, and as such, the computing flex nodes 107 and 109 may need to be modified by the meta-data in order to achieve optimal application behavior. In some examples, the load balancing service 102 or other application running on the computing node 101 (e.g., a containerized application building framework) includes these interface features as configuration parameters (e.g., throughput, latency, power consumption, and security features) in the application service requests that are provided to the provisioning manager 122 for provisioning the computing flex nodes 107 and 109.

The provisioning manager 122 selects meta-data and images containing bitstreams for configuring the configurable ICs 143 and 144 in selected ones of the computing flex nodes 107 and 109 and provides the selected images and meta-data to the provisioning executor 123. The provisioning executor 123 includes software that provides the images and meta-data received from the provisioning manager 122 to one or both of the computing flex nodes 107 and 109. The images received from the provisioning executor 123 are loaded into the configurable ICs 143-144 in the selected computing flex nodes 107 and 109. The configurable ICs 143-144 in the computing flex nodes 107 and 109 are then configured with the images containing the bitstreams to function as configured nodes 111 and 113, respectively. As a result, the provisioning services 108 and 110 associated with the computing flex nodes 107 and 109 are configured as provisioned services 112 and 114, respectively. In addition, the provisioning executor 123 notifies the load balancing service 102 that at least a subset of the application service requests have been assigned to computing flex nodes 107 and 109.

As specific examples that are not intended to be limiting, the provisioning manager 122 and the provisioning executor 123 can provision and configure the configurable ICs 143 and 144 in the computing flex nodes 107 and 109 as configured nodes 111 and 113 that implement provisioned services 112 and 114, respectively, such as one or more of a firewall service for primary computing node 101, an AI service (e.g., image recognition) for primary computing node 101, an IPU service for primary computing node 101, a user management service for primary computing node 101, a web server for primary computing node 101, an encryption/decryption service for primary computing node 101, storage services for primary computing node 101, and/or application acceleration tasks for primary computing node 101. Thus, the computing flex nodes 107 and 109 are configurable to perform a variety of different computing services.

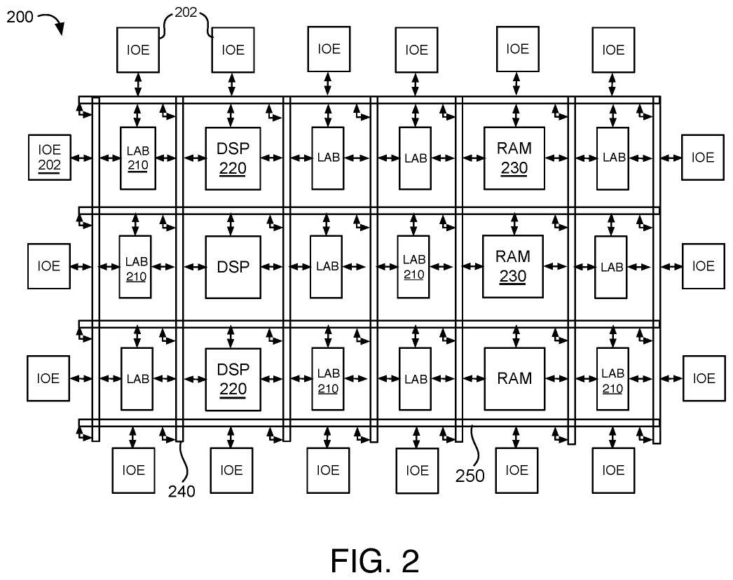

FIG. 2 is a diagram that illustrates an example of a configurable logic IC 200 that can implement techniques disclosed herein. CICs 143 and/or 144 disclosed herein in computing flex nodes 107 and 109 can include the architecture of configurable logic IC 200 according to some examples. As shown in FIG. 2, the configurable logic IC 200 includes a two-dimensional array of configurable logic circuit blocks, including configurable logic array blocks (LABs) 210 and other functional circuit blocks, such as random access memory (RAM) blocks 230 and digital signal processing (DSP) blocks 220. Functional blocks such as LABs 210 can include smaller configurable logic circuits (e.g., logic elements, logic blocks, or adaptive logic modules) that receive input signals and perform custom functions on the input signals to produce output signals.

In addition, configurable logic IC 200 can have input/output elements (IOEs) 202 for driving signals off of configurable logic IC 200 and for receiving signals from other devices. IOEs 202 may include parallel input/output circuitry, serial data transceiver circuitry, differential receiver and transmitter circuitry, or other circuitry used to connect one integrated circuit to another integrated circuit. As shown, IOEs 202 may be located around the periphery of the chip. If desired, the configurable logic IC 200 may have IOEs 202 arranged in different ways. For example, IOEs 202 may form one or more columns, rows, or islands of input/output elements that may be located anywhere on the configurable IC 200. Input/output elements 202 can include general purpose input/output (GPIO) circuitry (e.g., on the top and bottoms edges of IC 200), high-speed input/output (HSIO) circuitry (e.g., on the left edge of IC 200), and on-package input/output (OPIOs) circuitry (e.g., on the right edge of IC 200).

The configurable logic IC 200 can also include programmable interconnect circuitry in the form of vertical routing channels 240 (i.e., interconnects formed along a vertical axis of configurable logic IC 200) and horizontal routing channels 250 (i.e., interconnects formed along a horizontal axis of configurable logic IC 200), each routing channel including at least one track to route at least one wire. One or more of the routing channels 240 and/or 250 can be part of a network-on-chip (NOC) having router circuits.

Note that other routing topologies, besides the topology of the interconnect circuitry depicted in FIG. 2, can be used. For example, the routing topology may include wires that travel diagonally or that travel horizontally and vertically along different parts of their extent as well as wires that are perpendicular to the device plane in the case of three dimensional integrated circuits. The driver of a wire may be located at a different point than one end of a wire.

Furthermore, it should be understood that embodiments disclosed herein with respect to FIG. 1 can be implemented in any integrated circuit or electronic system. If desired, the functional blocks of such an integrated circuit can be arranged in more levels or layers in which multiple functional blocks are interconnected to form still larger blocks. Other device arrangements can use functional blocks that are not arranged in rows and columns.

Configurable logic IC 200 can contain programmable memory elements. Memory elements can be loaded with configuration data using IOEs 202. Once loaded, the memory elements each provide a corresponding static control signal that controls the operation of an associated configurable functional block (e.g., LABs 210, DSP blocks 220, RAM blocks 230, or IOEs 202). The configuration data can set the functions of the configurable functional circuit blocks (soft logic) in IC 200.

In a typical scenario, the outputs of the loaded memory elements are applied to the gates of field-effect transistors in a functional block to turn certain transistors on or off and thereby configure the logic in the functional block including the routing paths. Programmable logic circuit elements that are controlled in this way include parts of multiplexers (e.g., multiplexers used for forming routing paths in interconnect circuits), look-up tables, logic arrays, AND, OR, NAND, and NOR logic gates, pass gates, etc.

The memory elements can use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory or programmable memory elements.

The memory elements can be organized in a configuration memory array consisting of rows and columns. A data register that spans across all columns and an address register that spans across all rows may receive configuration data. The configuration data can be shifted onto the data register. When the appropriate address register is asserted, the data register writes the configuration data to the configuration memory bits of the row that was designated by the address register.

Configurable integrated circuit 200 can include configuration memory that is organized in sectors, whereby a sector can include the configuration bits that specify the function and/or interconnections of the subcomponents and wires in or crossing that sector. Each sector can include separate data and address registers.

The configurable IC of FIG. 2 is merely one example of an IC that can include embodiments disclosed herein. The embodiments disclosed herein may be incorporated into any suitable integrated circuit or system. For example, the embodiments disclosed herein can be incorporated into numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPGAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein may be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

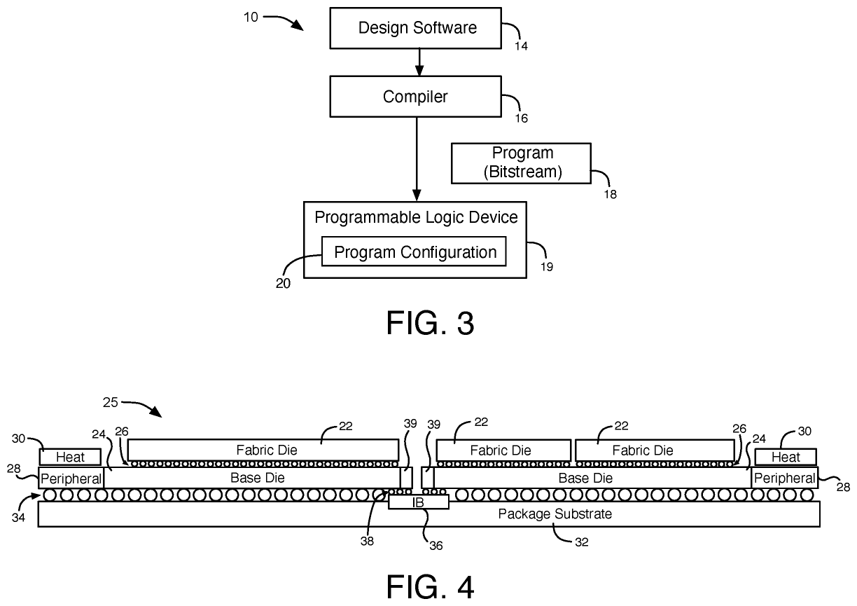

FIG. 3 illustrates a block diagram of a system 10 that can be used to implement a circuit design to be programmed onto a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized tasks.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 4, but many others can be used, and it should be understood that this disclosure is intended to encompass any suitable programmable logic device where programmable logic fabric and fabric support circuitry are at least partially separated on different integrated circuit die.

FIG. 4 is a diagram that depicts an example of a programmable logic device 25 that includes three fabric die 22 and two base die 24 that are connected to one another via microbumps 26. In the example of FIG. 4, at least some of the programmable logic fabric of the programmable logic device 25 is in the three fabric die 22, and at least some of the fabric support circuitry that operates the programmable logic fabric is in the two base die 24. For example, some of the circuitry of configurable IC 200 shown in FIG. 2 (e.g., LABs 210, DSP 220, RAM 230) can be located in the fabric die 22 and some of the circuitry of IC 200 (e.g., input/output elements 202) can be located in the base die 24.

Although the fabric die 22 and base die 24 appear in a one-to-one relationship or a two-to-one relationship in FIG. 4, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 25. The heat spreaders 30 can appear above, as pictured, and/or below the package (e.g., as a double-sided heat sink). The base die 24 can attach to a package substrate 32 via conductive bumps 34. In the example of FIG. 4, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 25 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

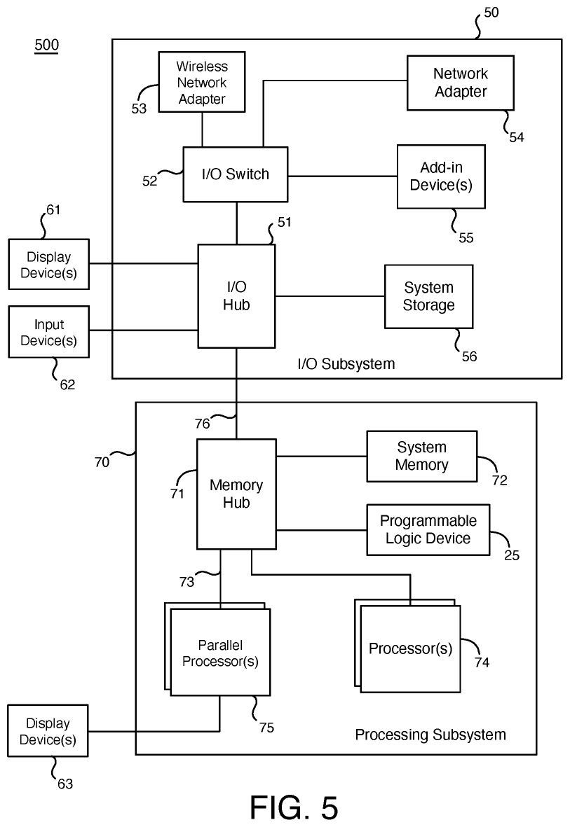

FIG. 5 is a block diagram illustrating a computing system 500 configured to implement one or more aspects of the embodiments described herein. The computing system 500 includes a processing subsystem 70 having one or more processor(s) 74, a system memory 72, and a programmable logic device 25 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 500 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 500. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 500 can include other components not shown in FIG. 5, including other port connections, optical storage drives, video capture devices, and the like, that can also be connected to the I/O hub 51. Communication paths interconnecting the various components in FIG. 5 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 500 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 500 can be integrated into a single package to form a system in package (SIP) configuration. In one embodiment, at least a portion of the components of the computing system 500 can be integrated into a multi-chip module (MCM), which can be interconnected with other multi-chip modules into a modular computing system.

The computing system 500 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 500. For example, any number of add-in cards or peripherals can be supported, or some components can be eliminated. Furthermore, some architectures can use different terminology for components similar to those illustrated in FIG. 5. For example, the memory hub 71 can be referred to as a Northbridge in some architectures, while the I/O hub 51 can be referred to as a Southbridge.

Additional examples are now described. Example 1 is an integrated circuit comprising: logic circuits that are configurable by a bitstream of configuration data to perform a computing service requested in a computing system, wherein the integrated circuit communicates with a central processing unit in the computing system according to interface features indicated by meta-data provided to the central processing unit to perform the computing service.

In Example 2, the integrated circuit of Example 1 can optionally include, wherein the logic circuits are configurable by the bitstream to perform an artificial intelligence service in the computing system.

In Example 3, the integrated circuit of any one of Examples 1-2 can optionally include, wherein the logic circuits are configurable by the bitstream to perform an infrastructure processing unit service in the computing system.

In Example 4, the integrated circuit of any one of Examples 1-3 can optionally include, wherein the interface features comprise at least one of throughput, latency, power consumption, or security features.

In Example 5, the integrated circuit of any one of Examples 1-4 can optionally include, wherein the logic circuits are partially reconfigurable by additional configuration data to perform modified computing functions.

In Example 6, the integrated circuit of any one of Examples 1-5 can optionally include, wherein the logic circuits are configurable by the bitstream to perform application acceleration tasks in the computing system.

In Example 7, the integrated circuit of any one of Examples 1-6 can optionally include, wherein the logic circuits are configurable by the bitstream to perform a firewall service in the computing system.

In Example 8, the integrated circuit of any one of Examples 1-7 can optionally include, wherein the logic circuits are configurable by the bitstream to perform encryption and decryption in the computing system.

In Example 9, the integrated circuit of any one of Examples 1-8 can optionally include, wherein the logic circuits are configurable by the bitstream to perform user management services for the computing system.

Example 10 is a method for configuring a computing system to perform a first computing service, the method comprising: receiving an application request for performing the first computing service from a primary computing node in the computing system; configuring a configurable integrated circuit in a secondary computing node in the computing system with an image in response to the application request to perform the first computing service; and communicating with the configurable integrated circuit in the secondary computing node according to interface parameters indicated by meta-data.

In Example 11, the method of Example 10 further comprises: receiving a second request for load balancing the first computing service and a second computing service between the secondary computing node and additional secondary computing nodes from the primary computing node.

In Example 12, the method of any one of Examples 10-11 further comprises: providing the image and the meta-data to the secondary computing node to perform the first computing service from a provisioning executor.

In Example 13, the method of Example 12 further comprises: selecting the image and the meta-data using a provisioning manager in response to receiving the application request for performing the first computing service; and providing the image and the meta-data to the provisioning executor.

In Example 14, the method of any one of Examples 10-13 can optionally include, wherein configuring the configurable integrated circuit in the secondary computing node to perform the first computing service comprises: configuring the configurable integrated circuit in the secondary computing node using the image to perform an artificial intelligence service for the computing system.

In Example 15, the method of any one of Examples 10-14 can optionally include, wherein configuring the configurable integrated circuit in the secondary computing node to perform the first computing service comprises: configuring the configurable integrated circuit in the secondary computing node using the image to perform an infrastructure processing unit service for the computing system.

Example 16 is a computing system comprising: a configurable integrated circuit configurable by an image comprising a bitstream to perform a computing service for the computing system; and a central processing device that communicates with the configurable integrated circuit according to interface features defined by meta-data provided to the central processing device.

In Example 17, the computing system of Example 16 can optionally include, wherein the interface features comprise at least one of throughput, latency, power consumption, or a security feature.

In Example 18, the computing system of any one of Examples 16-17 can optionally include, wherein the configurable integrated circuit is configurable to perform an artificial intelligence service for the computing system.

In Example 19, the computing system of any one of Examples 16-18 can optionally include, wherein the configurable integrated circuit is configurable to perform an infrastructure processing unit service for the computing system.

In Example 20, the computing system of any one of Examples 16-19 further comprises: a provisioning manager that accesses the image from a library of pre-built configuration images or from a synthesis tool that generates the image; and a provisioning executor that provides the meta-data to the central processing device and that provides the image to the configurable integrated circuit.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. An integrated circuit comprising:
logic circuits that are configurable by a bitstream of configuration data to perform a computing service requested in a computing system, wherein the integrated circuit communicates with a central processing unit in the computing system according to interface features indicated by meta-data provided to the central processing unit to perform the computing service.

2. The integrated circuit of claim 1, wherein the logic circuits are configurable by the bitstream to perform an artificial intelligence service in the computing system.

3. The integrated circuit of claim 1, wherein the logic circuits are configurable by the bitstream to perform an infrastructure processing unit service in the computing system.

4. The integrated circuit of claim 1, wherein the interface features comprise at least one of throughput, latency, power consumption, or security features.

5. The integrated circuit of claim 1, wherein the logic circuits are partially reconfigurable by additional configuration data to perform modified computing functions.

6. The integrated circuit of claim 1, wherein the logic circuits are configurable by the bitstream to perform application acceleration tasks in the computing system.

7. The integrated circuit of claim 1, wherein the logic circuits are configurable by the bitstream to perform a firewall service in the computing system.

8. The integrated circuit of claim 1, wherein the logic circuits are configurable by the bitstream to perform encryption and decryption in the computing system.

9. The integrated circuit of claim 1, wherein the logic circuits are configurable by the bitstream to perform user management services for the computing system.

10. A method for configuring a computing system to perform a first computing service, the method comprising:
receiving an application request for performing the first computing service from a primary computing node in the computing system;
configuring a configurable integrated circuit in a secondary computing node in the computing system with an image in response to the application request to perform the first computing service; and
communicating with the configurable integrated circuit in the secondary computing node according to interface parameters indicated by meta-data.

11. The method of claim 10 further comprising:
receiving a second request for load balancing the first computing service and a second computing service between the secondary computing node and additional secondary computing nodes from the primary computing node.

12. The method of claim 10 further comprising:
providing the image and the meta-data to the secondary computing node to perform the first computing service from a provisioning executor.

13. The method of claim 12 further comprising:
selecting the image and the meta-data using a provisioning manager in response to receiving the application request for performing the first computing service; and
providing the image and the meta-data to the provisioning executor.

14. The method of claim 10, wherein configuring the configurable integrated circuit in the secondary computing node to perform the first computing service comprises:
configuring the configurable integrated circuit in the secondary computing node using the image to perform an artificial intelligence service for the computing system.

15. The method of claim 10, wherein configuring the configurable integrated circuit in the secondary computing node to perform the first computing service comprises:
configuring the configurable integrated circuit in the secondary computing node using the image to perform an infrastructure processing unit service for the computing system.

16. A computing system comprising:
a configurable integrated circuit configurable by an image comprising a bitstream to perform a computing service for the computing system; and
a central processing device that communicates with the configurable integrated circuit according to interface features defined by meta-data provided to the central processing device.

17. The computing system of claim 16, wherein the interface features comprise at least one of throughput, latency, power consumption, or a security feature.

18. The computing system of claim 16, wherein the configurable integrated circuit is configurable to perform an artificial intelligence service for the computing system.

19. The computing system of claim 16, wherein the configurable integrated circuit is configurable to perform an infrastructure processing unit service for the computing system.

20. The computing system of claim 16 further comprising:
a provisioning manager that accesses the image from a library of pre-built configuration images or from a synthesis tool that generates the image; and
a provisioning executor that provides the meta-data to the central processing device and that provides the image to the configurable integrated circuit.
